(19) United States
(12) Patent Application Publication
(10) Pub. No.: US 2009/0106307 A1
(43) Pub. Date: Apr. 23, 2009

(54) SYSTEM OF A KNOWLEDGE MANAGEMENT AND NETWORKING ENVIRONMENT AND METHOD FOR PROVIDING ADVANCED FUNCTIONS THEREFOR

(76) Inventor: Nova SPIVACK, San Francisco, CA (US)

Correspondence Address: PERKINS COIE LLP, P.O. BOX 1208, SEATTLE, WA, 98111-1208, US

(21) Appl. No.: 12/244,740

(22) Filed: Oct. 2, 2008

Related U.S. Application Data
(63) Continuation-in-part of application No. 11/874,881, filed on Oct. 18, 2007.
Application No. 11/874,881 is a continuation-in-part of application No. 11/874,882, filed on Oct. 18, 2007.
(60) Provisional application No. 60/981,104, filed on Oct. 18, 2007.

(51) Int. Cl. G06F 17/30

(52) U.S. Cl. 707/103 R; 707/E17.055

(57) ABSTRACT

Systems and methods for advanced functions of a knowledge management and networking environment are disclosed. In one aspect, embodiments of the present disclosure include a method, which may be implemented on a system, of hosting a web-space having a plurality of objects. One embodiment can further include, identifying semantic metadata of the plurality of objects in the web-space, generating a portable set of collective knowledge from the plurality of objects, and enriching the portable set of collective knowledge with enriched data based on the semantic metadata identified from the plurality of objects. One embodiment can further include, detecting an edit to an object of the plurality of objects in the web-space and updating a source object of the object according to the edit.

### PRIORITY CLAIM

This application claims priority to U.S. Provisional Patent Application Ser. No. 60/981,104 filed Oct. 18, 2007, entitled “SYSTEM AND METHOD FOR ADVANCED FUNCTIONS OF A KNOWLEDGE MANAGEMENT AND NETWORKING ENVIRONMENT”, by Nova Spivack, the contents of which are expressly incorporated by reference herein.

This application is a continuation-in-part of U.S. patent application Ser. No. 11/874,881 filed Oct. 18, 2007, entitled “SYSTEM AND METHOD OF A KNOWLEDGE MANAGEMENT AND NETWORKING ENVIRONMENT”, by Nova Spivack, the contents of which are expressly incorporated by reference herein.

This application is a continuation-in-part of U.S. patent application Ser. No. 11/874,882 filed Oct. 18, 2007, entitled “SYSTEM AND METHOD OF A KNOWLEDGE MANAGEMENT AND NETWORKING ENVIRONMENT”, by Nova Spivack, the contents of which are expressly incorporated by reference herein.

### BACKGROUND

Human intelligence and knowledge is becoming increasingly digitized. Not only is information and data generated, created, and/or stored digitized form, frequently, knowledge, information, and other forms of intellectual content are increasingly distributed, offered, disseminated, collected, shared, and/or edited in digitized format.

Traditional formats of knowledge dissemination via books and magazines continue albeit various efforts exist to create digital formats of existing books and magazines such that they can be accessible via the Internet through channels such as online libraries with public or restricted (e.g., subscription-based, fee-based) access. Furthermore, scientific publications and research journals are becoming predominantly accessed by students, faculty, and/or researchers via online channels since they are typically available sooner than their hardcopy counterparts. Online dictionaries, encyclopedias, wikis (e.g., Wikipedia), have become an integral source of many formal and informal education processes.

In addition, due to ease of digital communication and dialogue to facilitate information exchange, intellectual content is being created in forms logged in formats such as through email messages, instant messaging, RSS, portable devices (e.g., SMS and email), digital images, videos, and/or online social networks, etc. The wide-array of formats in which intellectual content is being generated and/or distributed among has made knowledge management and collection a daunting task in the digital age.

For example, with the vast-array of digitized intellectual content distributed among various sources and in various formats, searching for the relevant information has become difficult. Web-based search engines that focus on keyword matches for various document fields such as author, abstract, key-topics, and/or full-text sometimes do not yield the most relevant search results to the user. In other situations, a keyword which is relevant to content of a specific topic, simply is not explicitly referenced in an article.

Further, managing ones knowledge collection via creating files and folders in ones desktop operating system no longer suffices the need to efficiently manage ones collection of content and for the user to effectively track and/or identify/locate the content of relevancy.

### BRIEF DESCRIPTION OF THE DRAWINGS

FIG. 1 illustrates a block diagram of a plurality of client devices able to communicate with content providers and a server hosting a knowledge management and networking environment and providing advanced functions through a network, according to one embodiment.

FIG. 2 depicts a block diagram of the components of a host server for a knowledge management and networking environment for providing advanced functions, according to one embodiment.

FIG. 3A depicts a block diagram illustrating a database for storing user information of users (visitors and/or service subscribers) and a database for storing user group information, according to one embodiment.

FIG. 3B depicts a block diagram of a database for storing items, a database for storing emails, and a database for storing photographs, according to one embodiment.

FIG. 3C depicts a block diagram of a database for storing popular searches, a database for storing popular tags, a database for storing popular nets, and a database for storing user nets, according to one embodiment.

FIG. 3D depicts a block diagram of a database for storing ontologies, according to one embodiment.

FIG. 4 depicts a block diagram illustrating hardware and/or software components of a system for providing various services and advanced functions offered by the knowledge management and networking environment, according to one embodiment.

FIG. 5A illustrates an example user interface showing a user welcome screen, according to one embodiment.

FIG. 5B-C illustrates an example user interface showing a view of objects (items) in a net and an example user interface for exploring/browsing nets, according to one embodiment.

FIG. 6 depicts a flow diagram illustrating an example process for enriching a portable set of collective knowledge, according to one embodiment.

FIG. 7 depicts a flow diagram illustrating an example process for providing version and revision control of an object, according to one embodiment.

FIG. 8 depicts a flow diagram illustrating an example process for providing adaptive services based on detected user behavior, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods of advanced functions of a knowledge management and networking environment (e.g., web-space), for example, through management and enrichment of a user's knowledge content.

Some embodiments of the present disclosure further include leveraging collective collaborative intelligence and knowledge contribution to provide advanced individual knowledge management, tracking, updating, editing, functionalities and other related services.

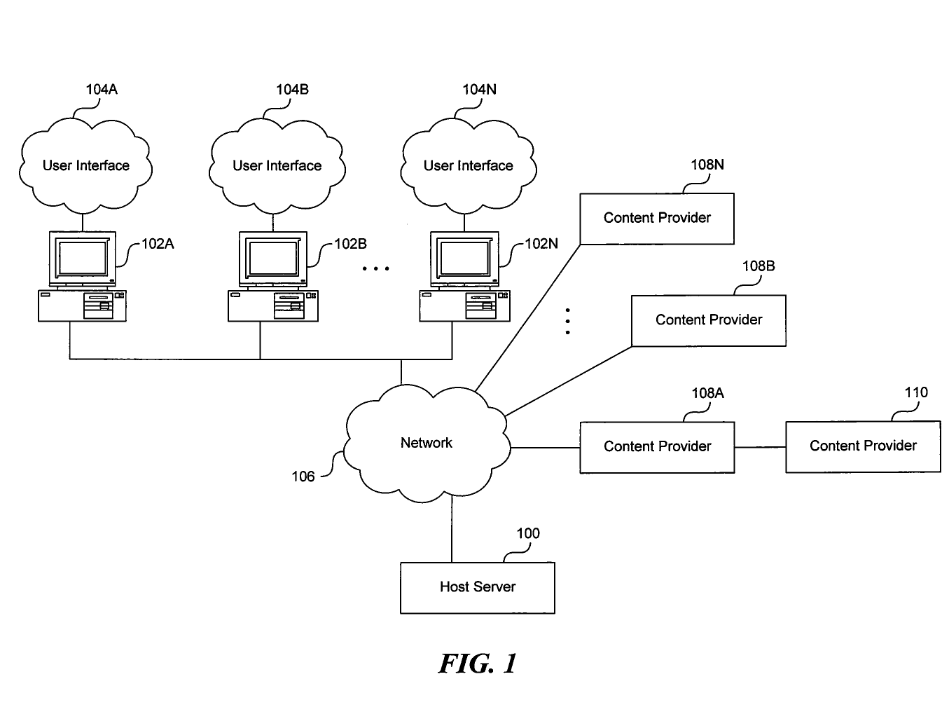

FIG. 1 illustrates a block diagram of client devices 104A-N able to communicate with content providers or users 108A-N, 110 and a server 100 hosting a knowledge networking environment and providing advanced functions through a network, according to one embodiment.

The plurality of client devices 104A-N and content providers 108A-N, 110 can be any system and/or device, and/or any combination of devices/systems that is able to establish a connection with another device, a server and/or other systems. The client devices 104A-N and content providers 108A-N, 110 typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 104A-N and content providers 108A-N, 110 are coupled to a network 106. In some embodiments, the modules may be directly connected to one another.

The network 106, over which the client devices 104A-N and content providers 108A-N, 110 communicate, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and/or the content providers 108A-N, 110 and may appear as one or more networks to the serviced systems and devices. In one embodiment, communications to and from the client devices 104A-N and content providers 108A-N, 110 can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

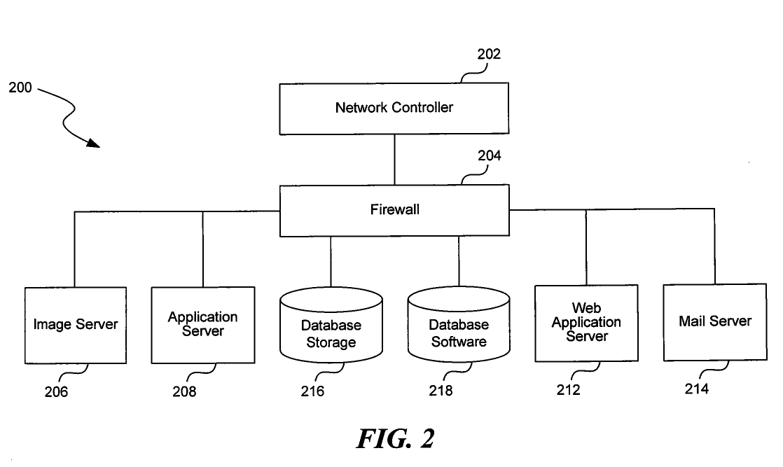

FIG. 2 depicts a block diagram of the components of a host server for a knowledge management and networking environment for providing advanced functions, according to one embodiment.

In the example of FIG. 2, the host server 200 includes a network controller 202, a firewall 204, an image server 206, an application server 208, a web application server 212, a mail server 214, and a database including a database storage 216 and database software 218.

In the example of FIG. 2, the network controller 202 can be a networking device that enables the host server 200 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The firewall 204, can, in some embodiments, govern and/or manage permission to access/proxy data in a computer network, and track varying levels of trust between different machines and/or applications. The firewall 204 can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall 204 may additionally manage and/or have access to an access control list which details permissions including for example, the access and operation rights of an object by an individual, a machine, and/or an application, and the circumstances under which the permission rights stand.

Other network security functions can be performed or included in the functions of the firewall 204, can be, for example, but are not limited to, intrusion-prevention, intrusion detection, next-generation firewall, personal firewall, etc. without deviating from the novel art of this disclosure. In some embodiments, the functionalities of the network controller 202 and the firewall 204 are partially or wholly combined and the functions of which can be implemented in any combination of software and/or hardware, in part or in whole.

In the example of FIG. 2, the host server 200 includes the image server 206 or a combination of image servers to manage images, photographs, animation, and/or other types of image data. The image server 206 is any web server software suitable for delivering messages to facilitate efficacious retrieval of image data in web servers to be provided to other components and/or systems of the host server 200, for example when rendering a web page with images. In addition, the image server 206 can facilitate streaming data such as streaming images and/or video. The image server 206 can be configured separately or together with the web application server 212, depending on a desired scalability of the host server 200. Examples of graphics file formats that can be managed by the image server 206 include but are not limited to, ADRG, ADRI, AI, GIF, IMA, GS, JPG, JP2, PNG, PSD, PSP, TIFF, and/or BMP, etc.

The application server 208 can be any combination of software agents and/or hardware modules for providing software applications to end users, external systems and/or devices. The application server 208 can facilitate interaction and communication with the web application server 212, or with other related applications and/or systems. The application server 208 can in some instances, be wholly or partially functionally integrated with the web application server 212. The web application server 212 is any combination of software agents and/or hardware modules for accepting Hypertext Transfer Protocol (HTTP) requests from end users, external systems, and/or external client devices and responding to the request by providing the requesters with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

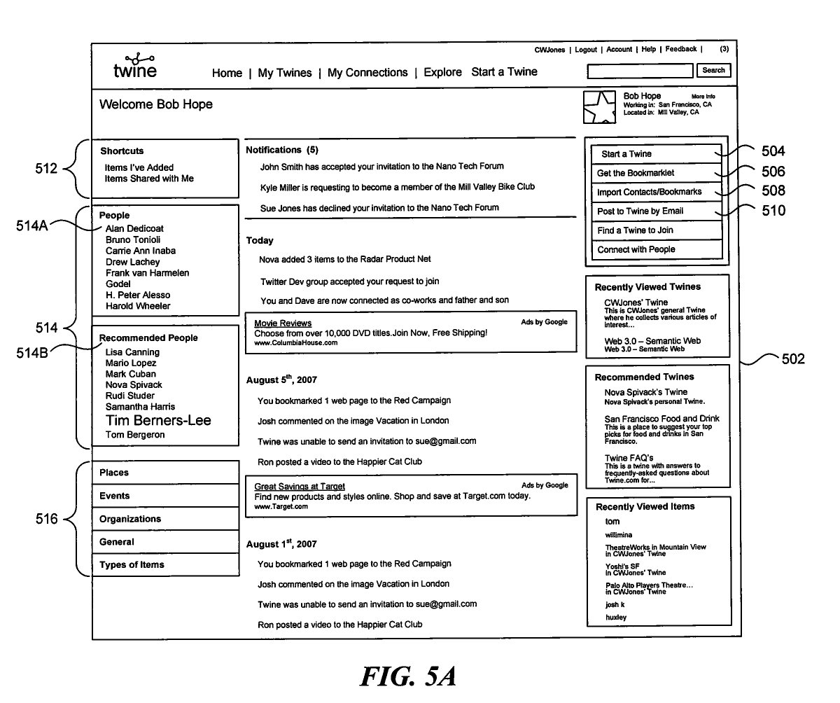

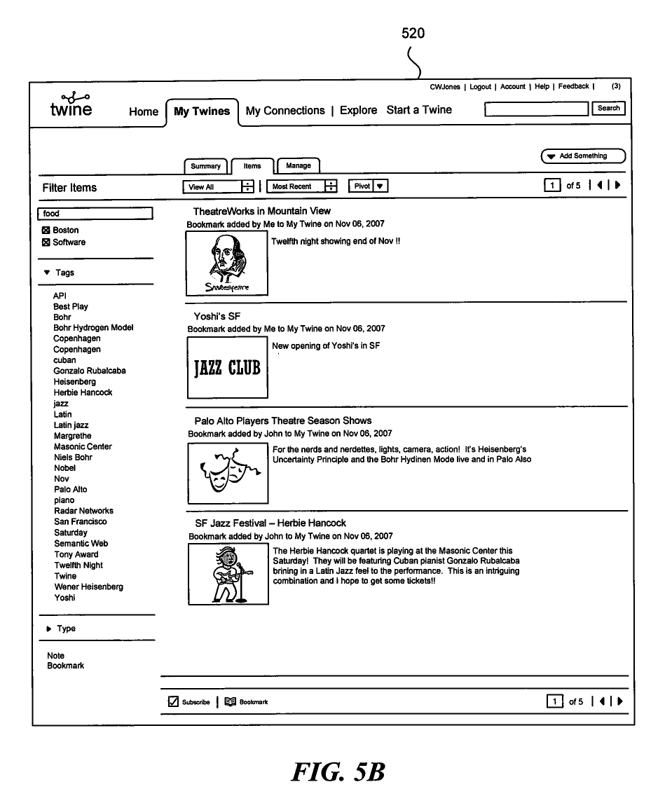

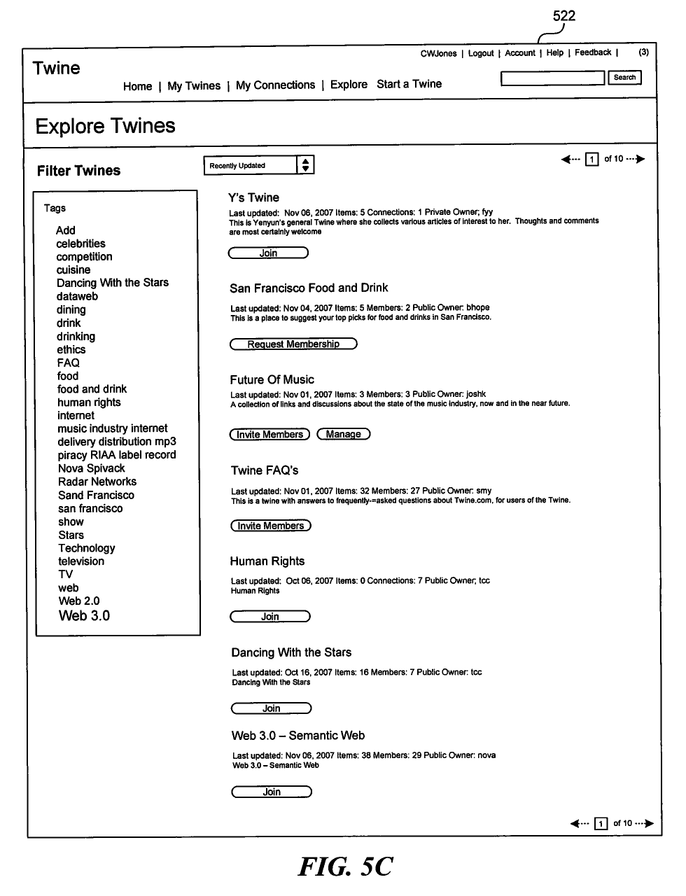

In addition, a secure connection, SSL and/or TLS can be established by the web application server 212. In some embodiments, the web application server 212 renders the web pages having graphic user interfaces of the networking environment as shown in the example screenshots of FIG. 5A-C. The web pages provided by the web application server 212 to client users/end devices enable user interface screens 104A-104N for example, to be displayed on client devices 102A-104N. In some embodiments, the web application server 212 also performs an authentication process before responding to requests for resource access and data retrieval.

In one embodiment, the host server 200 includes a mail server 214 including software agents and/or hardware modules for managing and transferring emails from one system to another, such as but is not limited to Sendmail, Postfix, Microsoft Exchange Server, Eudora, Novell NetMail, and/or IMail, etc. The mail server 214 can also store email messages received from the network. In one embodiment, the mail server 214 includes a storage component, a set of access rules which may be specified by users, a list of users and contact information of the users' contacts, and/or communication modules able to communicate over a network with a predetermined set of communication protocols.

The databases 216, 218 can store software, descriptive data, images, system information, drivers, and/or any other data item utilized by other components of the host server for operation. The databases 216, 218 may be managed by a database management system (DBMS), for example but not limited to, Oracle, DB2, Microsoft Access, Microsoft SQL Server, PostgreSQL, MySQL, FileMaker, etc. The databases 216, 218 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In the example of FIG. 2, the host server 200 includes components (e.g., a network controller, a firewall, a storage server, an application server, a web application server, a mail server, and/or a database including a database storage and database software, etc.) coupled to one another and each component is illustrated as being individual and distinct. However, in some embodiments, some or all of the components, and/or the functions represented by each of the components can be combined in any convenient or known manner. Furthermore, the functions represented by the devices can be implemented individually or in any combination thereof, in hardware, software, or a combination of hardware and software.

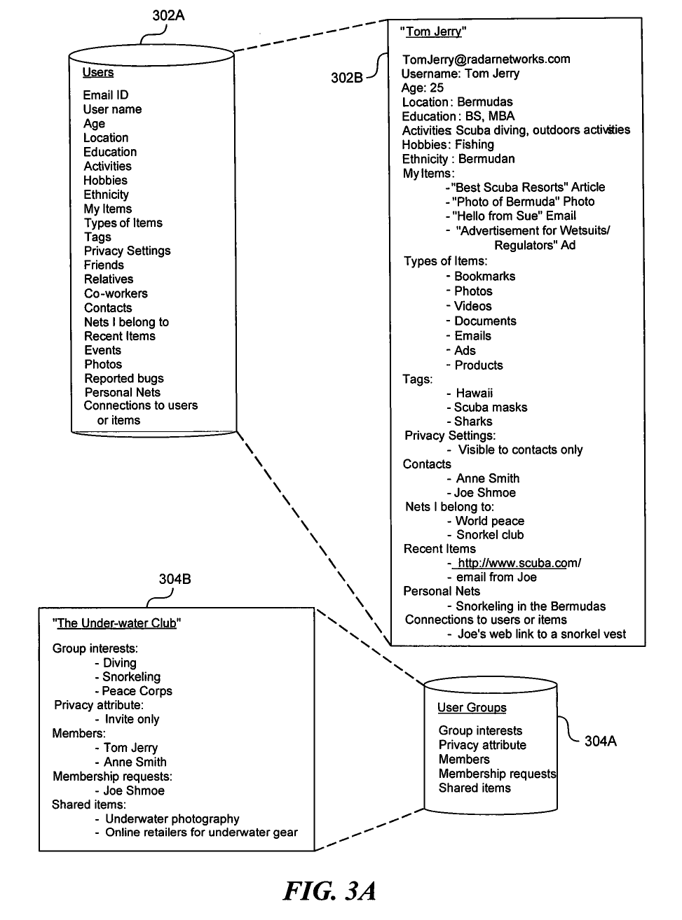

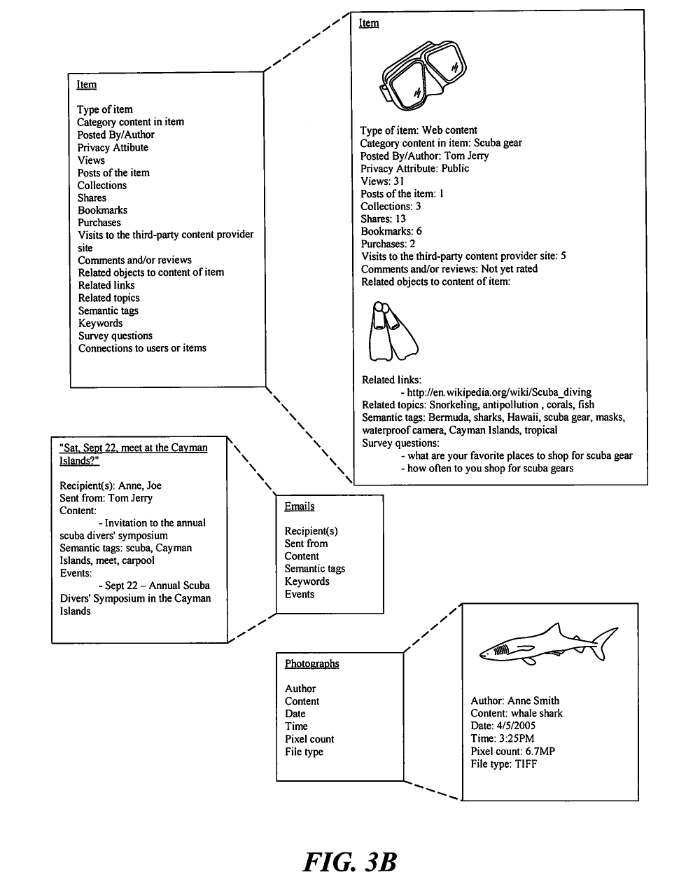

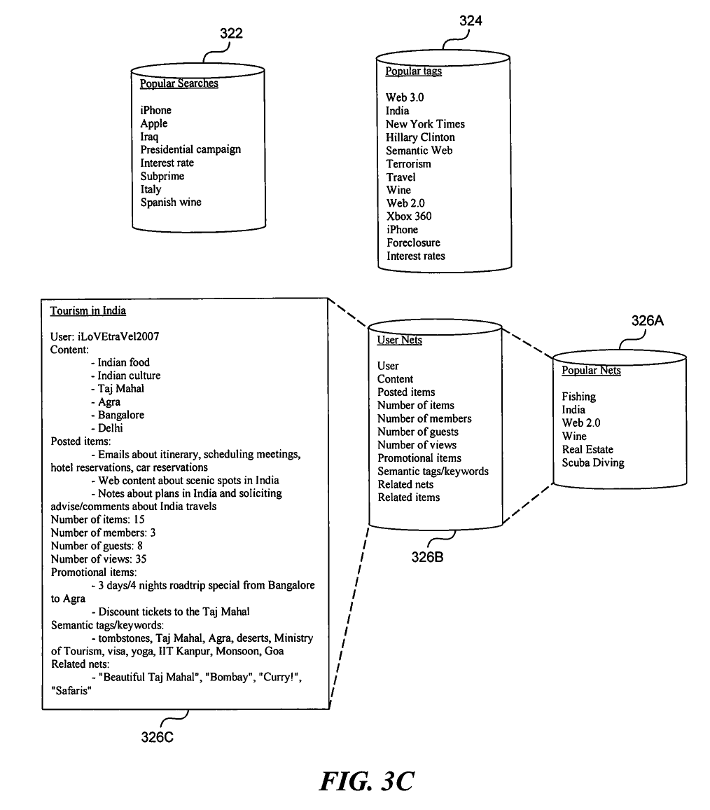

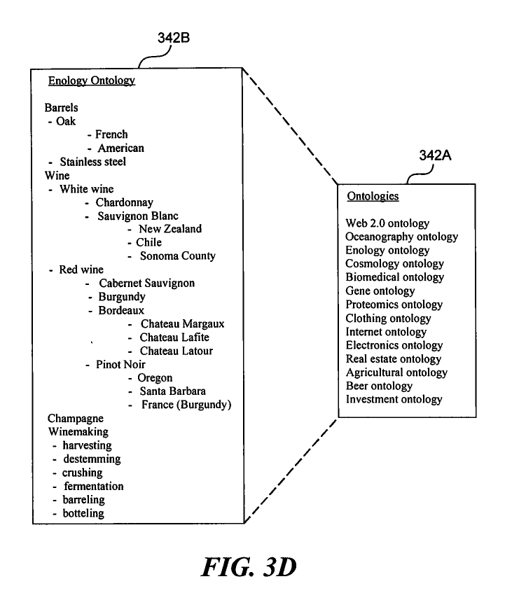

FIG. 3A depicts a block diagram illustrating a database for storing user information of users (visitors and/or service subscribers) 302 and a database for storing user group information 304, according to one embodiment.

In the example of FIG. 3A, the database 302A can store information about users, including visitors and/or service subscribers. For example, the user information stored can include descriptive data of personal information such as, but is not limited to, a first name and last name of the user, a valid email ID, a unique user name, age, marital status, occupation, location, education, home town, schools attended, number of siblings, heritage, ethnicity, race, etc. The user information further includes interest information, which may include, but is not limited to, activities, hobbies, professional information, photos, etc.

The database also stores web content (e.g., third-party) provided by the user, for example, the web content themselves can be stored, the types of web contents (e.g., email, vcf card, calendar events, web content, web links, etc.), tags in the web content, nets that the user belongs to, information of contacts, connections to other users and/or items, etc. In one embodiment, a user creates one or more nets with varying themes to which objects (e.g., web content) can be added. The user can also join nets created by other users and access items in the nets of the other users, while conforming to the access rights specified by the other users and specific for the nets. Further, in addition to storing information of contacts in the database, the user is able to connect to other users (e.g., visitors and/or service subscribers) and specify a designated relationship to the other users. The user's connections and the relationships of the connections (e.g., friends, relatives, and co-workers) are, in some embodiments, stored in the database.

In one embodiment, user information stored in the database is explicitly specified by the user. For example, when the user (e.g., visitor/service subscriber) signs up for access to the networking environment, a set of information may be required, such as a valid email address, a username, and/or age. A user information form can include optional entries, by way of example but not limitation, location, activity, hobbies, ethnicity, photos, etc. In one embodiment, user information is identified from web content the user added to the networking environment. For example, the networking environment can automatically determine user interests and/or hobbies based on the identified intellectual content of the web objects provided by the user. Hobbies and interest can also be determined by, for example, but are not limited to, the events that a user attends and/or common interests of a user's contacts.

Each entry or a category of entries (e.g., subscription information, personal information, interest information, etc.) related to user information in the database 302A can have permission settings regarding visibility and accessibility to other users. The privacy settings may, in some embodiments, vary between registered and non-registered users (visitors), contacts with different relationships with the user (e.g., a friend, colleague, family, etc.). In addition, the privacy settings may be different and individually specifiable for each contact of a user.

An example of the user information for the user “Tom Jerry” that is stored in database 302A is shown in 302B. The user “Tom Jerry” has an email address of “TomJerry@radametworks.com”, an age of “25”, is located in “Bermudas” and is “Bermudan” by ethnicity. The user “Tom Jerry” is recorded to have an education level of “BS, MBA”, and likes to engage in activities related to “Scuba Diving, outdoors activities”. Specifically, “Tom Jerry” is also interested in “Fishing”. The items that “Tom Jerry” has provided include web content, photographs, and emails.

The database 302A also records information about the content of the items, for example, the items provided by “Tom Jerry” includes “blogs on fishing” and “advertisements for wetsuits/regulators”, and “websites of online retailers selling scuba diving gear”; recent content includes http://www.scuba.com and “emails from Joe”; personal nets include “Snorkeling in the Bermudas”. The tags of Tom Jerry's web content include “Hawaii”, “Scuba masks”, and “Sharks”. “Tom Jerry” has also specified the privacy settings such that the contents of Tom Jerry's web objects and/or user information are “visible to contacts only”. Tom Jerry's contacts include “Anne Smith” and “Joe Shmoe”; he belongs to the nets “World Peace” and “Snorkel Club”; he is also connected to another user's item, for example “Joe's web link to a snorkel vest”.

With further reference to FIG. 3A, database 304A includes data related to information of user groups formed in the networking environment. A user can form a group, where invitees are invited to join the group. Alternatively, one or more users can create a group, for example, based on a common theme or interest. In other examples, groups may be formed as a channel for sharing information with a focused group of users within the networking environment, with or with out a common interest. Group data in the database 304A, includes, for example, shared interests represented by the group. The database, in addition, stores information about the privacy attributes of the group, which can indicate group membership criteria, access to information posted in the group between group members and visitors, for example. Certain content and/or information may only be visible and/or accessible to a subset of members of the group. In addition, items posted on the group net may not be visible to users that are not members of the group. The database further stores membership information regarding the members of the group, membership requests, and/or items that are shared between group members.

An example of group information stored in the database 304A is shown in 304B for “the Under-water Club”. The group interests include “diving”, “snorkeling”, and the “Peace Corps”. The privacy attributes of “The Under-water Club” are “invite only”, which indicates that a user can only join the group when a membership request is approved. Current members of “The Under-water club” include “Tom Jerry” and “Anne Smith”; a membership request is currently active for user “Joe Shmoe”. The shared items between the members of “The Under-water Club” include “Underwater Photography” and “Online retailers for underwater gear”.

FIG. 3B depicts a block diagram of a database for storing items 312A, a database for storing emails 314A, and a database for storing photographs 316A, according to one embodiment.

The database 312A can store data regarding information of items (referred to herein after as “item data”) provided by users. The items are, in some instances, web objects, such as, web content, emails, photography, emails, calendar events, contact information, etc. Item data stored in the database can also include information about the item type, the subject matter of the content provided in the item (e.g., whether the web content contains information regarding fishing, the presidential election, etc.), and/or who added the item to the networking environment (e.g., the user that posted the item, or the user that authored the item). Item data can also include information regarding the privacy attributes associated with the item. For example, if the item can be viewed publicly, if the item can only be viewed by registered users, if the item is blocked from particular users, if the item is public to users that belong to certain user groups, if the item is available upon request on an individual or subgroup basis, etc.

Item data may further include the number of views of the item. For example, the number of views can be stored as the total number of views since the item has been posted, the number of views for a predetermined amount of time (e.g., a day, an hour, last 12 hours, etc.), the total number of views from users that belong to a particular user group, from users having a particular interest, are some ways that popularity of an item can be determined. In some embodiments, the same item may be posted on the networking environment by different users, thus, the database can include item data to indicate how many users have posted the same item.

In addition, item data regarding the number of collections of an item can be stored in the database 312A. For example, once an item has been visited, a user may wish to add an item of interest to a net in the networking platform for future access. Similarly, a user may bookmark (e.g., add the link to the item as a bookmark in the web browser) an item for future access as an alternative to collecting the item. A user may also wish to share an item (e.g., that either the user posted on the networking environment or collected from another user) with a third user. In one embodiment, item data indicative of item popularity, including but not limited to, collection data, bookmarking data, and sharing data, data indicating shares with other nets, is stored in the database 312A.

Additional item data that may be indicative of item popularity include data of visits to the third-party web site hosting the web content provided by the item, transactions (e.g., purchases, sales, rents, leases, bids, etc.) that occurred due to viewing of the object via the networking environment, comments and/or reviews related to the web content provided by the object, for example. In one embodiment, item data stored in the database 312A include keywords identified from the content of the web object.

In some embodiments, item data include semantic tags identified from the web content, tagged by the system, tagged by the user that provided the web content, tagged by the third party content provider and/or tagged by the sponsor. Thus, in addition, content/items related to the web content, web links containing information related to the contents of the object, additional content including topics similar to content provided by the object can also be identified (e.g., based on a keyword match and/or a semantic match) and stored in the database 312A.

In one embodiment, survey questions can be presented to a user that demonstrated interest in the item. For example, interest can be indicated when the user clicks on a link to the item, when the user submits the item to the networking environment, when a user bookmarks the item, when a user shares the item, when a user collects the item, etc. The survey questions may be a predetermined default set of questions or the survey questions may be provided by the third-party that provided the web content. Thus, the survey questions associated with an item are stored in the database 312A, in one embodiment. The database 312A can further store data indicating the triggers that cause a particular survey question to be presented to a user. For example, a first set of questions can be presented to a user when the user adds the item to the networking environment, whereas a second set of questions are presented to a user when the user shares an item with another user on the networking environment.

An example of item data stored in the database 312A is shown in 312B. The type of the item is “web content” and content of the item belongs to the category of “Scuba gear”. The item is posted by/authored by “Tom Jerry” and its privacy attribute is “Public”. The item has had “31” views, “1” post, “3” collections, “13” shares, “6” bookmarks, and “2” purchases via the networking environment. The number of visits to the third-party content provider site from a viewing of the item on the networking environment is “5”. The item status for comments and/or review is “Not yet rated”.

An object that is related to the content of the item is stored on the database as an image of a pair of flippers. A related link to the content of the item is http://en.wikipedia.org/wiki/Scuba-diving. The related topics to item content include “Snorkeling”, “antipollution”, “corals”, and “fish”. The semantic tags related to the item include, “Bermuda”, “sharks”, “Hawaii”, “scuba gear”, “masks”, “waterproof camera”, “Cayman Islands”, and “tropical”. The survey questions associated with the item are “what are your favorite places to shop for scuba gear?” and “how often do you shop for scuba gear?”

The database 314A in the example of FIG. 3B stores the emails and data/information associated with the emails (referred to herein after as ‘email data’) added by the users to the networking environment. Examples of email data that are stored include but are not limited to the recipient(s) of the email, whom the email is sent from, the content of the email, the semantic tags associated with the email, the keywords identified from the text body of the email, and/or scheduled events identifiable via the body of the email.

An example of email data stored in the database 314A is shown in 314B. The title of subject line of the email is “Sat. September 22, meet at the Cayman Islands?” The recipients of the email are “Anne” and “Joe”, the email is sent from “Tom Jerry. The identified content of the email is an “Invitation to the annual scuba divers' symposium”. The semantic tags identified from the email, either tagged by a user, specified by the content provider, or automatically identified by the networking environment, are “scuba”, “Cayman Islands”, “meet”, and “carpool”. The identified event to be scheduled in this email is “September 22—Annual Scuba Divers' Symposium in the Cayman Islands”.

The database 316A in the example of FIG. 3B stores the photographs and data/information associated with the photographs (referred to herein after as ‘photograph data’) provided by the users to the networking environment. Examples of photograph data that are stored include but are not limited to the author of the photograph, the content of the photograph, the day/time the photograph was taken, saved, edited, and/or otherwise modified. The pixel count and file type of the photograph. An example of photograph data stored in the database 316A is shown in 316B. The author of the photograph is “Anne Smith”, and the contents of the photograph include the “whale shark”. The photograph was taken at “3:25 PM on Apr. 5, 2005”; the pixel count of the photograph is “6.7 MP” and the file type is “.TIFF”.

FIG. 3C depicts a block diagram of a database for storing popular searches 322, a database for storing popular tags 324, a database for storing popular nets 326A, and a database for storing user nets 326B, according to one embodiment.

The database 322 stores a list of popular searches that occurred on the networking environment. The popular searches can be determined based on the total number of searches that occurred for the keyword over a predetermined amount of time. Similarly, the popular searches can be determined based on the rate of increase in the number of searches for a particular keyword over a predetermined amount of time. In some embodiments, the searches for the same keyword that originate from the same user, IP address, or machine ID, for example, are factored in and not counted towards the tally towards determining popularity of a search term. In the example database 322 of FIG. 3C, the identified popular searches include the keywords “iPhone”, “Apple”, “Iraq”, “Presidential campaign”, “Interest rate”, “Subprime”, “Italy”, and “Spanish Wine”.

The database 324 stores a list of popular tags on the networking environment. The tags can, in some embodiments, be identified from items (e.g., web content, email, web objects, photographs, contacts, calendar events, etc.) provided by users in the networking environment. For example, an item can be tagged with keywords added by a user to the networking environment and/or be tagged automatically by the system based on a set of metadata/meta-tags associated with the item. In addition, the item may be tagged by the third-party provider of the item. In some embodiments, the meta-tags include semantic tags. Thus, items having topically similar and/or related content can be identified in the networking environment items database and counted towards identifying the popular tags.

Additionally, tags indicating similar and/or related keywords and tags can be identified in user information databases in determining the popular tags on the networking environment. Additional methods and/or algorithms for identifying popular tags are contemplated and expected and do not deviate from the novel art of this disclosure. In the example database 324 of FIG. 3C, the identified popular tags include “Web 3.0”, “India”, “New York Times”, “Hillary Clinton”, “Semantic Web”, “Terrorism”, “Travel”, “Wine”, “Web 2.0”, “Xbox 360”, “iPhone”, “Foreclosure”, and “Interest rates”.

The database 326A stores a list of popular nets on the networking environment. In the example database 326A of FIG. 3C, the identified popular nets stored in database 326A include “Fishing”, “India”, “Web 2.0”, “Wine”, “Real Estate”, and “Scuba Diving”. In one embodiment, each net that is identified as popular in the database 326A is an individual net and determined as ‘popular’ based on the number of members in the net. Alternatively, the popularity can be determined by the total number of views of the net over a predetermined amount of time, regardless of whether the net was viewed by a registered user or a visitor. The popularity can also be determined by the rate of increase of views over a predetermined amount of time. In some embodiments, the popularity is determined by the total number of views of the net generated by users who are not members of the net.

In some embodiments, the views generated by the same user in a net do not count towards the number of views that determine popularity of a net. In one embodiment, each identified popular net includes a plurality of nets that relate to a similar topic. For example, the popular net “India” may include the nets having topics similar to but is not limited to the “Taj Mahal”, “tombstones”, “Bangalore”, “Bombay”, “authentic curry”, etc. Since in some embodiments, the contents of the nets have semantic meta-tags, other related content (e.g., similar and/or related content on other nets) shared on the networking environment are identified and a set of popular nets having similar and/or related content can be determined.

The database 326B stores the user nets and data/information associated with the user nets (hereinafter referred to as ‘user net data’). The user net data stored in the database 326B can include, for example, but is not limited to, the user(s) who created the net, the contents of the net, items posted in the net, the number of items posted in the net, the number of members in the net, the number of guest visitors in the net, the number of views, promotional items, semantic tags and/or keywords, related nets, and/or related items.

One or more users can create a net, for example, to facilitate information/knowledge sharing and/or to provide centralized access to a set of data/information. In addition, since in some embodiments, semantic meta-data tagging enables similar and/or related data/information to be identified on the networking environment, nets can be created by a user to add information and to identify additional related information provided by other users through items added by the other users and/or the nets created by the other users. The additional items and nets of other users can be stored in the database 326B such that when the net is accessed by a user, the user is apprised of related or similar items and nets that may be of interest to the user. The items in a net may or may not have a common theme or topic of interest. Thus, the identified contents of the net, either based on keyword matches, semantic matches, as identified automatically, by the user, and/or by the third party content provider, can be stored in the database 326B. In one embodiment, a list of promotion items provided in the net is stored in the database 326B. A promotional item can be a third party advertisement or other types of endorsements for a product and/or service added to the net by a user or members of the net.

An example of user net data stored in the database 326B is shown in 326C. The user that created the net “Tourism in India” has a user name of “iLoVEtraVel2007”, and the contents of the net include “Indian food”, “Indian culture”, “Taj Mahal”, “Agra”, “Bangalore”, and “Delhi”. The items posted on the net include “Emails about itinerary”, “scheduled meetings”, “hotel reservations”, and “car reservations”, “web content about scenic spots in India”, and “Notes about plans in India and soliciting advise/comments about India Travels”.

The number of items posted in the net is ‘15’, the number of members of the net is ‘3’, the number of guests to the net is ‘8’, and the number of views of the net is ‘35’. The promotional items in the net include “3 days/4 nights road trip special from Bangalore to Agra”, and “Discount tickets to the Taj Mahal”. The semantic tags/keywords determined in the items included in the net include “tombstones”, “Taj Mahal”, “Agra”, “deserts”, Ministry of Tourism”, “visa”, “yoga”, “IIT Kanpur”, “Monsoon”, and “Goa”. Nets related to “Tourism in India” include “Beautiful Taj Mahal”, “Bombay”, “Curry!”, and “Safaris”.

FIG. 3D depicts a block diagram of a database for storing ontologies 342A and a database for storing promotional content sponsorship information 344A, according to one embodiment.

The database 342A stores the ontologies available in the networking environment. The ontologies can be provided and integrated by administrators of the networking environment. In addition, ontologies can be requested by a user to be added into the platform, or added to the platform by a user. In the example database 342A of FIG. 3D, the currently available ontologies include the ontologies for “Web 2.0”, “Oceanography”, “Enology”, “cosmology”, “Biomedical Ontology”, “Proteomics”, “Clothing”, “Internet”, “Electronics”, “Real estate”, “Agricultural”, “Beer”, and “Investment”. An example of a portion of the enology ontology stored in the database 342A is shown in 342B. The enology ontology includes a list of the different types of barrels (“Oak” (e.g., French oak and American oak), “Stainless Steel”, different types of wines (“White wine (e.g., Chardonnay and Sauvignon Blanc), “Red wine” (e.g., Cabernet Sauvignon, Burgundy, Bordeaux, and Pinot Noir), “Champagne”, and the different steps involved in wine making (“harvesting”, “destemming”, “crushing”, “fermentation”, “barreling”, and “bottling”).

In some embodiments, one or more databases can be implemented as one database and different types of information can be stored in combination rather than in separation as shown in the example databases of FIG. 3A-3D.

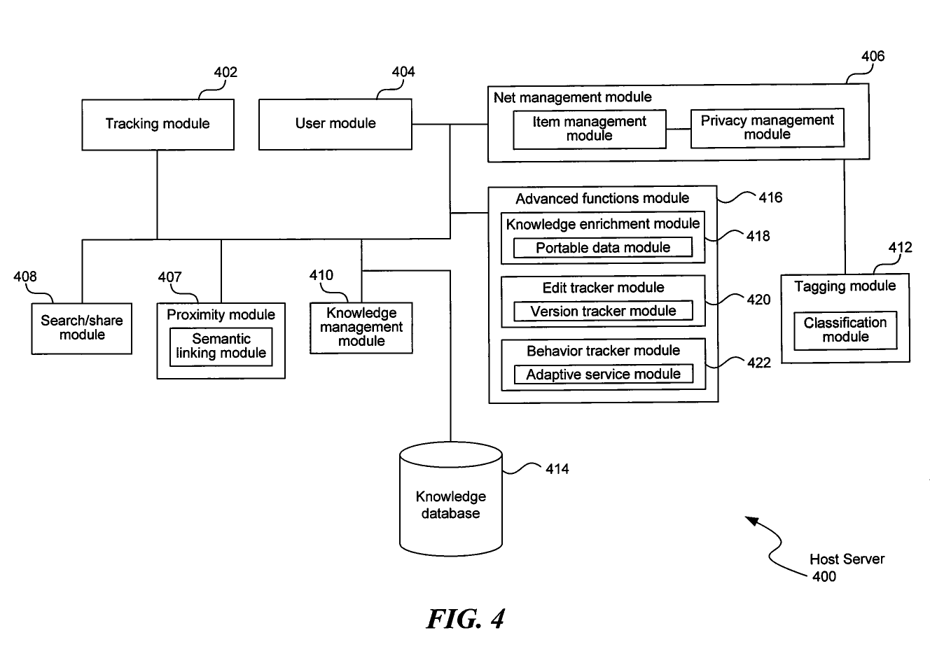

FIG. 4 depicts a block diagram illustrating hardware and/or software components of a system for providing various services and advanced functions offered by the knowledge management and networking environment, according to one embodiment.

In the example of FIG. 4, the host server 400 is one embodiment of the system. The system includes a tracking module 402, a user module 404, a net management module 406 having an item management module and/or a privacy management module, a search/share module 407, a proximity module 408 having a semantic social linking module, a knowledge management module 410, a knowledge database 414, and/or a tagging module 412 having a classification module.

Additional or less modules can be included without deviating from the novel art of this disclosure. In addition, each module in the example of FIG. 4 can include any number and combination of sub-modules, and systems, implemented with any combination of hardware and/or software modules.

The host server 400, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The tracking module 402 can be any combination of software agents and/or hardware modules able to track user activity related to web content added to the networking environment (e.g., knowledge networking environment). For example, the tracking module 402 records the instances when web content added to the networking environment is viewed, who viewed the web content, and the time and date the content is viewed. The data can be stored in the system for a predetermined amount of time, as suitable. The tracking module may also record the instances when the web content is bookmarked, collected, shared with another user and/or net, and who bookmarks, collects, and/or shares the content. The recipient and the net receiving the web content can also be recorded. In some instances, the tracking module also records different users add the same content to the networking environment, since identical web content added by different users can be an indication of interest.

In one embodiment, the tracking module 402 determines when a user views a third-party web page in response to viewing web content in the networking environment. The tracking module can also record when additional actions (e.g., purchase, sale, lease, rent, bid, ask a questions, post a comment, send a message, send an email, etc.) occur in response to viewing web content, in particular, web content having promotional content. In most instances, the identities of the parties involved in the action are recorded. In some embodiments, the tracking module 402 collects numerical data regarding content access/distribution and performs elementary statistical analysis on the data collected. In some embodiments, elementary statistical analysis and/or additional data analysis methods are performed in a market data module (not shown).

For example, the tracking module 402 can record the number and percentage of visitors that collected the web content, visitors that collected the web content then shared the web content, visitors who made a purchase based on the web content. The tracking module 402 may also record the average number of subsequent shares per user that has viewed the web content, the average number of visits to the web content before collecting it. In one embodiment, the tracking module 402 determines when a user collects web content, the average number of repeat visits to web content per user prior to collecting the web content. The total number of users that the web content has spread to can be determined by the tracking module 402. In addition, the velocity and/or the acceleration of the spread of the web content can be determined and recorded.

In one embodiment, the tracking module 402 determines the total volume of collections, shares, bookmarks, shares, purchases for web content over a predetermined amount of time. For example, the daily volume of the total number of users that collected an advertisement for the iPhone can be determined and stored. In one embodiment, the tracking module 402 can determine which users are the top spreaders of the web content. In some embodiments, the tracking module 402 distinguishes between a visitor who is not a subscriber and a visitor who is a subscriber and records the subscription status of a user who accessed and/or distributed web content.

The user module 404 can be any combination of software agents and/or hardware modules able to identify user metadata from a set of user information. The user information can be supplied by the user and/or identified by the networking environment. For example, the user information can include basic profile information submitted by the user during registration, such as a first and last name, birth date, location, etc. In addition, the user may have the option of submitting additional information including but is not limited to, nationality, religion, ethnicity, interests, hobbies, occupation, education, etc. as described in detail in FIG. 3A. User information can also be identified based on user activity on the networking environment.

For example, general interest can be identified from common topics or themes in the content added by a user to the networking environment. Similarly, general interest can be determined based on commonalities between the user and the user's contacts and/or connections on the networking environment. In one embodiment, user information can be deduced from visits to other users' nets and views of content provided by other users. Additionally, web content collected and/or bookmarked by the user provides additional information about the user. The type of the web content (e.g., a web page, an email, a photograph, etc.) in addition to the intellectual content of the web content (e.g., the subject matter of an online news paper article) can both be utilized to obtain user information.

In some embodiments, the user module 404 communicates or otherwise shares information with the tracking module 402 such that access/distribution data can be associated with user data about the users involved in the access and distribution of web content. For example, demographic, geographic, and/or psychographic analysis can be performed on the data collected in relation to access and distribution of web content, in particular, promotional content. Alternatively, the data identified and stored by the tracking module 402 and the user module 404 can be stored in a common data depository (e.g., on the tracking module, on the user modules, or external to the tracking and user modules) such that data recorded by the tracking and user modules can be retrieved independently or in conjunction, as necessary.

The net management module 406 can be any combination of software agents and/or hardware modules able to provide the services related to management of nets. The management of nets include those related to, but is not limited to, setting up the parameters for net creation, as specified by, for example, a net creator (e.g., administrative user), managing membership requests of the net, and/or privacy rights of various objects (e.g., items) in the net. Generally, nets are created to store intellectual information and/or knowledge in various digital formats for an individual, group, team, and/or community. Web-based items in addition to users, user profiles and/or user contact information can be associated with a net. In most instances, the net is a web-space for an individual or group to manage and organize collective knowledge having dispersed or similar topics, and to share/collect information from other members of the net.

Objects can be added by the net creator to the net. Other users, such as members and/or visitors can, in some situations, be allowed to contribute to the intellectual content of the net. For example, for a particular net, content added may be required by net administrators to be related to one or more specific topics. The net may also limit who can contribute content to the net. Objects can be added to nets in a variety of ways. For example, users can upload existing files from their devices (e.g., cell phone, portable device, computer, desktop, laptop, Blackberry, iPod, iPhone, etc.) to one or more nets. In particular, various types of files, including but are not limited to, documents, .pdfs, text files, video files, email messages, image files, audio files, of varying formats can be uploaded to knowledge networking environment. An URL can be submitted to add web-content hosted by a third-party content provider to the net. In addition, intellectual content can be created in the knowledge networking environment. For example, a note can be composed in an interface provided by the networking environment and submitted to be posted in one or more nets.

In one embodiment, objects (e.g., files, documents, RSS, contact records, video, image, and/or audio files) are added to a particular net via attaching the objects to an email and sending the email to an email address unique to the particular net. In some embodiments, a net be associated with different email addresses to be used when posting objects with different privacy settings. For example, addresses such as “owner.twineDogLovers.com”, “members.twineDogLovers.com”, and/or “public.twineDogLovers.com” can be used to post objects to the net “DogLovers” but with three different levels of privacy access settings.

When a net is created, the net management module 406 can query the creator user (e.g., administrative user) whether the net is to be a personal net, a group net, or a public net. Typically, objects added to a net of designated type personal net are private and only visible to the creator user. Of course, this setting is modifiable by the creator to allow certain other users to view a sub-set of content in the net. The creator, in some instances, designates other users/members of the net to have administrative rights. Similarly, objects added to a net that is designed as a group net (or shared net) are typically visible to the members of the net. Objects added to a net that is designed as a public net are typically visible to the public. For example, contents in a public net can, in addition to being visible to members of the net, are visible to visitors of the net, and/or visitors of the knowledge networking environment. In some embodiments, objects in the pubic net are identifiable via a publicly accessible search engine (e.g., Google, Yahoo, and/or MSN, etc.).

Levels of privacy settings related to access and viewing of objects in nets are contemplated beyond that described for private, group, and public. For example, a net can have a customizable privacy level as specified by the net creator and/or other users with administrative rights. In one embodiment, a net can have content with different privacy settings. For example, the net creator and/or other administrative users can specify the objects that are of a particular privacy access level, based on predetermined criteria. In addition, the user that added the object to the net is typically able to set the privacy settings associated with the added object.

A user and/or a group of users can create multiple nets in the knowledge networking environment. In some situations, multiple nets can be created by a particular user, where the multiple nets have different privacy settings, respectively. In one embodiment, the net management module 406 manages the different nets can be created by a particular user with different privacy settings. In some embodiments, the net management module 406 includes a privacy management module to track the privacy settings of the nets and the privacy settings of individual objects (items) in a net.

In some embodiments, a net in the context of the knowledge networking environment is referred to herein as a “Twine”. A “Twine” is considered to be synonymous in meaning with what is referred to herein in this disclosure as a ‘net’ and is also associated with all and/or additional the functions performed and services offered by a net, in accordance with at least the embodiments described throughout the present disclosure.

The item management module can be any combination of software agents and/or hardware modules able to track any activity or the lack of, related to web content that has been added to the networking environment. The item management module can manage objects (e.g., web content) added to the networking environment and delete objects in response to receiving a request from a user with rights to delete the objects.

In one embodiment, the item management module identifies a number of rules associated with privacy and/or access rights of the object. For example, a user can specify a set of relational attributes when adding content to the networking environment. Relational attributes can include, for example, who can see the content, the users that can see the content, or a particular group of users that can see the content. In some embodiments, a set of users with a predetermined relationship (e.g., family) of the user can view the content. In addition, relational attributes can further include who can edit the content, share the content, collect the content, and/or bookmark the content. Similar to content viewing rights, edit, commenting, asking a question, sharing, collecting, bookmarking rights can be specified by default, on an individual basis, on a relationship basis, or on a group basis (e.g., only users who are subscribers can edit the content).

In one embodiment, the item management module identifies the preferences of a content provider associated with accessibility of the web content when the content provider is a third-party host of the web content. The preferences can be determined from metadata associated with the web content. For example, the third-party host may not permit edits/modifications to be made to the web content. In addition, the third-party host may limit the number of shares that can be made on the networking environment. Thus, in one embodiment, the item management module determines a set of rules governing accessibility of the web content based on the relational attributes specifiable by the user who adds the web content and the preferences of the third-party host of the web content, when applicable. When users share and distribute web content in the networking environment, the item management module enforces the set of rules.

The search/share module 407 can be any combination of software agents and/or hardware modules able to facilitate intelligent searching and sharing of objects, nets, contacts among users in the knowledge networking platform. Since relationships between objects (e.g., users, user profiles, items, contact information, nets) in the web-space associated with the networking platform are known and/or otherwise identifiable, advanced search functionalities can thus be provided in the knowledge networking environment. For example, since content is typically associated with users (e.g., by virtue of the content being added by users, content having commented on by users, and/or content having been edited by users) a search parameter can allow a search user to specify the degree of separation within which to perform the search query. For example, a user may wish to see content related to ‘scuba diving’ associated with (e.g., posted by, commented by, moderated by, edited by, tagged by, rated by, and/or annotated by, etc.) users and/or contacts that are within three degrees of separation from the user.

In addition, the search parameter may allow the search user to specify the types of relationships within which to conduct the search. For example, a patent attorney may wish to see posted content related to new rules published by the United States Patent and Trademark Office that is associated with colleagues who are patent attorneys from the same law firm as the search user, and/or patent attorneys from a specified set of law firms. Further variations of utilizing identifiable relationships (semantic relationships, keyword relationships, etc.) between objects in the web-space to provide users with the ability to specify a targeted search scope are contemplated and considered to be within the scope of this novel disclosure.

Some search parameters include, by way of example but not limitation, search all available nets, search all content viewable only to me in a net, search all content viewable by members in a net, search content in a particular net, search all available nets, search nets including those I don't belong to, search nets associated with my connections, search nets associated with friends, search nets associated with colleagues, etc. Further, users can specify to search nets having tagged with specific tags (e.g., dogs, scuba, sharks, etc.). In addition, multiple search parameters are typically supported for further refining the search scope to one or more different types of relationship. For example, users can select to search and/or post to nets that are within a specified social distance from the user. In a further example, users can specify to search nets of first degree friends and are members of the DogLover's Net and are friends of Joe.

Similar to searching, when posting and/or otherwise sharing content, users can specify a targeted set of audience (e.g., users and nets). Some post parameters include, by way of example but not limitation, post to the user's net, post to the owner (or administrators) of a net, post to members of a net, post to a net but make viewable by public, post to second degree contacts that are employed by a particular company, post to nets of friends, post to nets of colleagues, post to nets that the user belongs to, post to nets having a predetermined set of tags identified, etc.

In some embodiments, the search/share module 407 is further able to provide educated recommendations to users, for example, users that opt-in to receive recommendations from the system and/or other users. In other words, the search/share module 407, in some embodiments, provides push-model based sharing. Since the knowledge networking environment, based on a user's profile, history, objects, nets, friends, etc., can deduce types of content and/or subject matter that the user is likely to be interested in, the search/share module 407 can present a list of objects/items likely to be of interest to the user.

In addition to user browsing history, recommendations can be made based on search history and items/web-pages the user is currently viewing. However, depending on the owner of the recommended objects/items, the user may or may not have immediate access. For example, item/object owners can specify to have objects be partially visible (e.g., title, summary, and/or abstract) to other users who do not have default access to the owner's items (e.g., they are not connected, they are not related, they are not friends, their social distance is not within a predetermined degree of separation, etc.).

If the user determines, for example, based on the partial visibility that the item is of interest, the search/share module 407, provides a pathway for the user to request the owner for access to the particular item of interest. Upon receiving an authorization from the owner, the search/share module 407 can present the requested items to the user. In other embodiments, recommended items are immediately available for access to the user if the owner does not have restricted privacy settings. Note that recommendations and sharing need not necessarily occur between users that are connected in any specified manner, if at all. Recommendations can be made by virtue of owners of items allowing their items to be at least partially shared and recipients who opt in to receive recommendations. In addition, sharing between users not initially connected provides an avenue through which to meet other users and/or to become connected in the network, for example.

The proximity module 408 can be any combination of software agents and/or hardware modules able to determine the social distance between objects in the knowledge networking environment. In general, social distance is proportional to the degrees of separation that a user and/or item is from a user of interest. For example, a first degree contact is a user that is directly connected to the user of interest. A second degree contact is a connection of a first degree contact of the user that is not directly connected to the user. Since items in the knowledge networking platform are linked to users (e.g., owners that added (posted) an item, edited an item, commented on an item, tagged an item, etc.), social distances can be determined between items and other users.

Further, the proximity module 408 is, in some embodiments, able to track semantic relationships between objects. In one embodiment, the proximity module identifies a semantic relationship between a user profile and another user's object. Similarly, relationships between objects/nets of user ‘John’s' and objects/nets of user ‘Mary’s' can be identified by the proximity module 408 based on keyword matches and/or semantic relationships. By identifying such relationships among the set of objects and users in the knowledge networking environment, social distances between objects and users can be determined.

Thus, in one embodiment, the proximity module 408 communicates with the search/share module 407 to facilitate in performing searching and sharing functions to be carried out within a particular social scope. For example, the proximity module 408 can provide a list of users that satisfy a set of search criteria specified by a search user and the search/share module 407 performs a search on nets and items associated with the list of users. The search criteria, as detailed previously, can be a particular social distance, a range of social distances, a particular type of relationship, and/or a combination of any of the above. In some embodiments, the functions represented by the proximity module 408 and the search/share module 407 are partially and/or wholly combined and can be implemented with one or many modules.

In some embodiments, search results are provided to a search user in a format that indicates the social distance of each search result to the user, via a collaborative effort between the search/share module 407 and the proximity module 408. In a further embodiment, search results are ranked based on the degree of separation between the search user and the items in the search results. For example, in addition to keyword relevance and/or semantic relation, ranking of search results can factor in social distance.

In one embodiment, the proximity module includes the semantic social linking module. The semantic social linking module can be any combination of software agents and/or hardware modules able to identify relationships between users based on semantic/keyword relationships between items/nets associated with the users. In most instances, the explicit relationships are identified based on user-triggered events whereas the implicit relationships are identified based on links (e.g., social, semantic, keyword, semantic social) determined by the knowledge networking environment.

The knowledge management module 410 can be any combination of software agents and/or hardware modules able to organize, compile, assimilate, manage, and/or analyze information/knowledge associated with the networking platform. The information/knowledge can be those provided by users and/or a knowledge database (e.g., knowledge database 414) created by system administrators. For example, the knowledge database can include, by way of example but not limitation, sets of ontologies, taxonomies and/or folksonomies. The knowledge database 414 in some instances, includes, dictionaries, thesauruses, and/or encyclopedias, etc.

In some embodiments, the knowledge management module 410 compiles information gathered from the networking environment and stores the information in the knowledge database 414 for future reference and access. The information compiled can be based on user behavior, information submitted by users, edits provided by users, tags specified by users. For example, the knowledge management module 410 can provide a channel for users to make a collection of their top items considered by the users to be of general facility and/or interest to other users. User's top items can be stored in the knowledge database 414 to be provided to other users via a recommendation or request.

In addition, the knowledge management module 410 can provide a facility for users to post questions and to solicit answers from other users. In some embodiments, a rating system is provided for answers and the users that provide the answers for quality control purposes. The questions and answers collected from users can further enrich the contents of the knowledge database. For example, when the same question is asked by another user, the knowledge management module can retrieve the answers previously stored in the knowledge management module 414. Similarly, other user oriented services such as responses to offers and requests, products/service listings, reviews of services and products, facts/statistical data, FAQ's, How-to's, can be solicited among users and stored as general knowledge in the knowledge database. Therefore, the knowledge database 414 is thus update-able and adaptable, based on, for example, knowledge acquired from user submission and/or from identified user behavior.

The tagging module 412 can be any combination of software agents and/or hardware modules able to identify one or more of keywords, tags, meta-tags, semantic tags from user metadata, user behavior on the networking environment, and/or metadata of web content. Semantic tags can be identified based on one or more of many methods. In one embodiment, tags are identified in content via natural language processing (NLP). The natural language processing method can detect nouns, proper nouns, verbs, subject, predicate, object and/or other parts of speech as well as grammatical expressions such as phrases and other constructions. For example, proper nouns can be turned into tags. When the tags are clicked, a query can be made to locate other web content and/or items with that tag, and/or with any text that matches that tag.

In one embodiment, tags are identified via entity extraction, by, for example, combining NLP and ontologies of concept and rules. The combination of NLP and ontologies can detect classes of concepts in intellectual content and semantically classify the concepts as, one or more of but not limited to, people, companies, places, addresses, phone numbers, general concepts, or finer classifications of the above (e.g., products, events, schools, celebrities, presidential candidates, etc.). New objects against which objects are to be detected via entity extraction can be regularly entered into the system. For example, new objects can be created of types, person, organization, place, and/or product, etc. In addition, new tags can be continuously added based on identified user behavior, such as tags added, edited, commented, connected, and/or annotated by users, etc. Therefore, in one embodiment, content in the knowledge networking environment is re-analyzed by the tagging module 412 to update existing tags and/or to identify new tags.

For example, tags with errors can be updated and tags previously not identified can now be tagged. The re-analyzing can occur at predetermined intervals. In some embodiments, the reanalysis can take place automatically when a predetermined amount of new objects and/or tags have been updated in the system. Further, the re-analysis can be manually triggered. For example, when a user adds a new organization object (“Stanford University”) into the knowledge networking environment, existing content that references “Stanford University” is identified and tagged.

In one embodiment, tags are identified via a Bayesian classification process thus enabling identification of one or more subject matter/concepts the web content and/or an item encompasses. In some instances, the subject matter can be identified even when the subject matter is not explicitly mentioned in the web content. For example an article describing process and procedure through which the Declaration of Independence was drafted can be identified as being related to “politics” and “history” and tagged as such, even though neither the words “politics” nor “history” were necessarily explicitly stated in the article. In one embodiment, subject matter can be identified based on Bayesian statistical techniques and performing machine learning to analyze a knowledge (information) database with a predetermined structure (e.g., including for example, encyclopedias, dictionaries, thesaurus, such as, but is not limited to, the Wikipedia, encyclopedia.com, Britannica.com, MSN Encarta, dictionary.com, thesaurus.com, techweb.com, etc.).

For example, the Wikipedia contains approximately 300,000 declared subject categories, which are specially named pages in Wikipedia. Other pages in the Wikipedia that represent the content or articles of Wikipedia are linked to the subject category pages for the subjects they are relevant to. In one embodiment, classified articles in Wikipedia having a particular subject matter (e.g., “history”) in the Wikipedia are utilized as “training inputs” for the Bayesian classification process. Machine learning can then be performed on the classified articles of the knowledge (information) database to determine a set of statistical classification rules for identifying content that is an indication of the particular subject matter (e.g., “history”). The amount of “training inputs” can be adjusted, in one embodiment, as suitable to the application.

When a suitable amount of “training data” is provided for a particular subject matter (e.g., “history”), an estimated probability that an object having text is about the subject matter (e.g., “history”) can be provided via the Bayesian classification process. In most instances, the accuracy and precision of estimated probability that a set of content is about the particular subject matter, increases with the quantity of “training data” provided during the machine learning process. The same procedure can be applied to additional subject matter and/or concepts.

In one embodiment, the classification process is performed in a hierarchical manner, since, for example, the structure of the original database for which a statistical model is built is also hierarchical. For example, a set of content can initially be analyzed to determine if it is about a particular subject matter (“history”). Then, the content can be analyzed to determine if it is about a child-subject matter (“history of America”) of the subject matter (“history”). If the content is about the “history of America”, then the content can further be analyzed to determine if subject matter further relates to a child-subject matter (e.g., “Declaration of Independence”) of the “history of America”, and so on and so forth to further narrow and precisely identify one or more subject matter.

In one embodiment, tags are identified via comparing textual data in the network platform (e.g., text that occurs in emails, notes, added web content, photographs, user profile, user metadata, etc.) to text that occurs in other content on the networking environment. For example, if an article includes one or more references to “Super Solar”, and additional content on the network is identified to have one or more references to “Super Solar”, then the term “Super Solar” can be an identified tag. When the term “Super Solar” is again detected in other content, the term “Super Solar” can be tagged in the other content. Thus, in one embodiment, significant phrases can be determined via detecting presence of the phrases in one or more contents (e.g., items, objects, web content, notes, photographs, emails, etc.) in the networking environment. In some instances, for example, even when the phrases are not identifiable by NLP, entity extraction, Bayesian classification and/or explicit links,

In one embodiment, tags are identified via determining and analyzing distribution of nouns and phrases that occur in the content in the networking environment over time and user metadata. For example, nouns and phrases that are frequently used may be identified as tags when they are mentioned. In some embodiments, additional filters may be necessary to screen out noise expressions to further hone in on the nouns and phrases representative of topics rather than common expressions or words.

In some embodiments, tags can be stored as strings or semantic objects. For example, tags can be created as semantic objects upon detection. Alternatively, in some embodiments, tags are created as text-based objects and converted to a semantic object, on an as-needed basis, for example. In one embodiment, the tagging module 412 converts string-based tags into semantic tags. For example, tags can be converted into semantic objects when a user wishes to edit the tags. Editing can include reporting tags that are incorrect, annotating tags with a comment, linking tags, defining tags, and/or rating tags, etc. In a further example, when a user elects to assign a broader and/or narrower tag to an existing string-based tag, the string-based tag can be converted to a semantic object. In addition, the broader and/or narrower tags can also be converted to semantic objects if they are initially string-based. In one embodiment, records of tag edits and/or tag creations by users are stored and/or analyzed. Records may include who performed the edit and/or when a tag was edited, in addition to the edits made to the tag.

By observing user tagging activities (e.g., editing, adding, commenting, removing, etc.), the knowledge networking environment can refine and, in some instances, adapt its tagging process. For example, new auto-tagging rules may be acquired as the system identifies tags previously not automatically detected but are manually added by a number of users. In addition, the system can learn, from user tags, the categories of tags. For example, if a user adds a tag “TechCrunch40” as a tag in a new type “Conferences” for that tag, the system can create a new category “Conferences” with the term “TechCrunch40” as a conference. In addition, if another user now tags the “Paris Convention” as of a tag category conference, both terms “TechCrunch40” and “Paris Convention” will be identified as tags having a category of type conference when identified in other articles/documents.

In one embodiment, string-based tags are converted to semantic objects when tags are mined from an existing knowledge database with a predetermined structure (e.g., imported ontologies, taxonomies, etc.). Since the imported ontologies and/or taxonomies are structured and cannot be attached to string-based tags, the tags are converted to semantic objects to mirror the structure of the particular ontology or taxonomy. In some embodiments, a tag-prefix indicating the category of the tag is represented as a semantic tag. Alternatively, a tag-prefix indicating the category of a tag can be string-based.

Semantic representations of tags allow tags to be linked to other tags via links identified via taxonomic relationships, including, but is not limited to, “has narrower tag”, “has broader tag”, “has synonymous tag”, “has antonym tag”, etc. Therefore, the relations between tags can be search such that, for example, when a user searches for items tagged with “science”, items tagged with narrower tags related to science as well, such as things tagged with physics, biology, chemistry, etc. For example, a user may select to see items having the tag “physics”. The knowledge networking environment can additionally present the user with options to “view items with broader tags” and/or “view items with narrower tags”, for example. Once selected, items with narrow tags or broader tags can be presented to the user. In addition, the user can select to view items with further narrower and/or broader tags.

One embodiment of the host server 400 further includes an advanced functions module 416. The advanced functions module 416 can be any combination of software agents and/or hardware modules able to enrich/enhance knowledge, track edits, and/or user behavior in the web-space. One embodiment of the advanced functions module 416 includes a knowledge enrichment module 418, an edit tracker module 420, and/or a behavior tracker module 422.

In one aspect, the present disclosure relates to generating a portable set of collective knowledge via importing and exporting between various platforms and in some embodiments, performing format conversion if necessary.

In one embodiment, the collective knowledge is enriched in the knowledge networking environment (or, web-space) by the knowledge enrichment module 418 based on identified semantic data or relationships (e.g., social and/or semantic) in the data. The knowledge enrichment module 418 can communicate with the knowledge management module 410 and/or the knowledge database 414 to obtain the data to be enriched and the enriching data. For example, the collective knowledge may be enriched with data based on the semantic metadata identified from the plurality of objects in the web-space.

In one embodiment, a portable set of collective knowledge is generated from the plurality of objects, for example, by the portable data module. The enriched knowledge can further be exported to various other platforms, devices, and/or individuals including all or a portion of the enriched data such that a user can have the collective knowledge (original, enriched, or partially enriched) distributed among various physical locations, at different workspaces, residences, among different user devices, portable and/or non-portable, in a variety of formats, if so needed.

Objects imported into the knowledge network (e.g., web-space) from various sources (e.g., third party, local storage, user devices, etc.) can be analyzed semantically and connected to other objects, content, nets, and/or users. For example, when bookmarks are imported from a third-party source (e.g., Delicious), the knowledge enrichment module 418 can mine the URL for the web-pages linked by the bookmarks and scan the content for tags, etc. The related information found, linked, added by, and/or otherwise associated with the original imported information can systematically be added to the imported objects, for example, by the knowledge enrichment module 418. Records of related information and data association are made and tracked, and in some embodiments, associated with the object instance by the knowledge enrichment module 418.

In some embodiments, the collective knowledge/information/data added to the networking environment can further be exported to one or more external platforms, user devices, and/or any other device with storage capabilities. When the collective information is exported, in some embodiments, the information enrichment provided by the knowledge network is exported too. For example, when contact information is imported into the networking platform, the contact information of a friend can be enriched with, the friend's contacts, the web-page of a friend's URL, a map of the friend's address in the contact information.

When the contact information is exported from the knowledge network for example, to Outlook, the contact entry may now further include the information enriched by the knowledge enrichment module 418. In addition, tags and metadata for files and documents imported into the networking environment can now be exported along with the files and documents itself. The importing or exporting the portable set of collective knowledge to or from the web-space to various platforms can be performed by the portable data module in the knowledge enrichment module 418.

In a further example, when a calendar event (outlook calendar event, Google calendar event, iCal event, etc.) is imported into the knowledge network, the calendar event is associated, automatically and/or manually, based on semantic and/or keyword relations with other items, objects, including emails, notes, documents, multimedia files, web pages, people, and/or other calendar events. This added knowledge (enrichment) related to the calendar event can be made visible when exported back to its source, for example, Outlook calendar.

Note that all or a portion of information/data added to the knowledge network can be manually and/or automatically synchronized with one or more different platforms, devices, and/or settings. The frequency of auto-synchronization can be adaptive (e.g., determined by the networking environment) and/or predetermined (e.g., pre-set by the user), as suitable. Therefore, the knowledge enrichment module 418 provides users with a channel to manage/organize, and/or enrich their knowledge and export the knowledge to, for example, portable devices.

For example, the importing or exporting is performed based on automatic or semi-automatic synchronization managed by the portable data module. Thus, the networking environment provides a mode for users to, have constant access to their collective set of knowledge, that is updated, and in most instances, additionally enriched with collective knowledge contributed by participation of other users. For example, if a new bookmark is added, the networking environment can add the new bookmark to other devices associated with the user such that the user can have access to such a bookmark when browsing the web via other devices.

One embodiment of the advanced functions module 416 further includes an edit tracker module 420. The advanced functions module 416 can be any combination of software agents and/or hardware modules able to detect, identify, track, record, store, and/or compile edits, revisions, or other types of changes to objects in the knowledge network (web-space).

In some embodiments, when objects added to the knowledge network are edited, for example, when edits are made to images, videos, documents, .pdf files, and the like, the edit tracker module 420 can detect the edit and automatically update the source file (e.g., the original external file that was added to the network) according to the edit.

Similarly, when the original external file is edited external to the knowledge network, the edits can automatically be updated by the edit tracker module 420 to the corresponding files in the knowledge network as well. Of course, edit synchronization may or may not occur depending on user preferences, user specifications, and/or default settings. Edit synchronization can occur after a predetermined number of edits or when each edit occurs, depending on suitability. Different items may have different synchronization frequency settings as well.

In a further aspect of the present disclosure, the knowledge networking environment provides version control, version tracking, revision tracking of items added to the network based on edit tracking.

Version/revision tracking can be provided at the level of a set of object, on a per-object level, and/or at the level of a field of an object. In one embodiment, version tracking is performed by the version tracker module in the edit tracker module 420. Edits/revisions can be tracked and stored at any granularity so desired or so deemed suitable on a per-object, per set of object, and/or per-field of an object basis by the edit tracker module 420. The granularity of the tracked set of edits is also adjustable as suitable.

Therefore, past versions of objects that have been edited/revised are typically accessible. Therefore, an object can be rolled back to a previous version. For example, a user can specify to access a version of document X as it was on a particular day. In some embodiments, edits made to an item and the time an edit was made is stored by the edit tracker module 420. In addition, information about the editor can be stored as well. In most instances, when edits and revisions are made, the object as-is prior to revision, rather than being deleted and/or overwritten, is rather saved, in addition to the version of the object, as-edited, therefore, allowing users to select older versions of an object.

In addition to tracking edits to objects, changes to individual fields of an object can be tracked/logged in a similar fashion, thus allowing users to rollback to different versions of an object field, for example, by specifying a temporal parameter associated with a change or a version of the object field. An object field can be, by way of example but not limitation, an author field, a summary field, a metadata field, a tag field, a date created field, a date modified field, etc. Changes to the fields can be time-stamped and/or user stamped to create a map to identify specific versions of a particular object field. In some embodiments, the newest version of a set of objects, an object, and/or an object field is marked as the current active version.

In a further embodiment, when performing search on content in the networking environment, by default, the search can be performed on current active version of various contents. In addition, search can be performed on past versions as well, for a particular time range, a time splice for example, or for all existing versions of content in the network. The version tracker module can communicate with the search/share module 417 to enable searching over various versions of a document or object. The default setting may be different for different types of objects (e.g., whether the object is a document, video file, a contact, a calendar event, or an audio file). Further, search settings may be user specifiable, to be search session specific, or user specific, and/or object type specific, for example.

In some situations, multiple users may be making conflicting changes to an object, an object set, and/or an object field. For example, user A change the author of an article to Jane Smith while user B changes the author to Bob Doe. In one embodiment, the knowledge network utilizes branching to save parallel versions of the document. Then, in some embodiments, using standard deviation control methods, for example, user can select which branch to keep. The user can also have the option to merge them, for example both Jane Smith and Bob Doe may be authors of the article. The user can also have the option of keeping the branches, deleting the branches, rolling back the branches, and/or editing one or more branches. When an object having branched version is displayed to a user, an indication that multiple versions of the object exists can also be provided to the user.

One embodiment of the advanced functions module 416 further includes a behavior tracking module 422. The behavior tracking module 422 can be any combination of software agents and/or hardware modules able to detect, identify, track, record, store, aggregate, and/or compile user behavior and/or actions in the web-space.

In a further aspect of the present disclosure, the knowledge networking environment provides adaptive services, in an aggregate manner, for a specific group of users (e.g., users in a group, in a net, etc.) and/or for individual users based on the aggregated detected user behavior, for example, tracked by the behavior tracking module 422.

In particular, the adaptive servicing is, in some embodiments provided by the adaptive service module and is enabled by the ability of the behavior tracking module 422 to collect user actions in the environment and to deduce information from the collective information regarding user actions and in some instances, user behavior. For example, the behavior tracking module 422 can acquire/develop additional rules for tagging based on identified user actions associated with tags. As users edit (e.g., add, annotate, group, categorize, edit fields, delete, etc.), the behavior tracking module 422, in one embodiment, logs this information and learns from this information to better tag content in the future. User tagging and tag editing trends can be tracked for all users, a group of users, and/or individual users.

For example, the behavior tracking module 422 may determine that users between the age groups of 12-22 have a tendency to tag content with the word ‘awesome’, where as users between the age groups of 35-65 have a tendency to delete the tag ‘awesome’. The behavior tracking module 422 can then, perhaps deduce that younger users prefer to have ‘awesome’ tagged whereas older users don't. In the future, when analyzing content for tags the deduced rules may be applied. Similarly, the behavior tracking module 422 may determine that users belonging to certain user groups or nets like certain tags better than others, etc.

When a user edits tags, the behavior tracking module 422 can derive information about or leading to user preferences for how to tag certain types of objects (e.g., a user may tag documents and video files differently), user preferences to how to tag particular items, and/or knowledge regarding to intellectual content about the object being tagged. For example, the knowledge networking environment can determine that an article is about politics and war when a user tags the article as such.

In a further example, when a user tags a web-page about the health benefits of an apple with a tag ‘fruit’, the networking environment acquires knowledge about the web-page being related to a ‘fruit’. However, when a user tags a web-page about the fourth quarter earnings results of Apple Computers with a tag ‘Company’, the networking environment acquires knowledge that ‘Apple Computers’ is of type ‘company’.

The behavior tracking module 422 may acquire additional rules based on other tagging behavior related to the string ‘apple’ to determine in the future, whether it is related a fruit or a company. For example, the networking may determine that users with certain types of characteristics (e.g., age, gender, occupation, hobbies, etc.) are more likely to identify apples of type ‘fruit’ than Apple of type ‘company’. These rules can be continuously updated and refined based on further aggregated/collected user behavior and applied in the future to tag contents for providing adaptive services for example, via the adaptive service module.

In addition, the knowledge networking environment is able to learn from mistakes using the aggregated behavior recorded by the behavior tracker module 422. The aggregated detected user behavior can be used to identify system mistakes and to subsequently identify a set of actions to learn and correct those mistakes. For example, if the network mistakenly tags a person's name as being a company name, and multiple users correct that, the network environment makes note and, can, in the future, start to tag the term as a person's name. This may be performed by the adaptive service module in the behavior tracker module 422. In some embodiments, when a potential mistake is identified by a user, the networking environment utilizes one or more of many methods (e.g., experimental test cases) to determine if indeed, a mistake has been made and thus actions should be taken for other objects in the network for which a tagging error has been made.

For example, the behavior tracker module 422 can deliberately incorrectly categorize a tag for a set of users to see if the test set of users identify the mistake. In a further example, the networking environment can simply query other users if a particular tag should be categorized as A or B, in lieu of and/or in addition to executing experimental test cases on sets of users.

In some embodiments, a quantitative threshold exists for the network environment to adjust, modify, and/or change one or more rules when edits/corrections are identified by users in the network. The quantitative threshold may exist in one or more of many forms, for example, a frequency that a particular change occurs, the total number of a particular change that occurs, the total number of users associated with a particular change, etc. In some embodiments, when rules are changed and new rules are applied, users may be queried to see if they agree with the new changes. For example, user may be queried for permission: “The network has noticed you always tag bookmarks from Sue as ‘important’—do you want the network to automate this from now on?” Other forms of user verification and cross checking methods are contemplated and are considered to be within the novel scope of this disclosure.

Many processes and criteria can exist for filter through user edits and to, in some embodiments, selectively determine which edits to deduce information from.

In some instances, different edits/actions/behaviors of different users may be weighed differently when the behavior tracker module 422 is deducing information from aggregate behavior. For example, some users may be trusted more and be awarded higher authority, by one or more of many pathways, including, comments on a particular user by other users, the comments the particular user provides in the network, and/or determined by the networking environment. In some embodiments, user may proclaim to be experts on specific subject matter and thus their edits are awarded additional weight. Other methods of user credentials verification, utilization, and cross validation methods are contemplated and considered to be within the scope of this disclosure. User credentials can be used in many ways for the networking environment to acquire, refine, and/or correct knowledge in a selective and intelligent manner, and are all considered to be within the scope of the novel art of this disclosure.

In yet another aspect of the present disclosure, the networking environment provides a facility for users to add, delete and/or to specify custom fields (e.g., the object fields are user-editable, user-specifiable, and/or user-definable) on objects in the network. The advanced functions module 416 can manage or track these object field that are user editable or user definable.

New objects can be defined by users as well. When new objects and/or object fields are defined, they are identified by the advanced functions module 416 as having provenance as being in a namespace for the particular user, a user group, a net, and/or for the entire knowledge networking environment. Therefore, the user edits for new fields and/or objects may initially be visible and applicable only for the user and/or other users in the name space, or for particular user groups, for example. Later, as suitable, based on user specification or system determination, the changes can be provided to additional sets of user, either narrower, broader, and/or different sets.

For example, when a user adds a new field to the Note item form in the knowledge networking environment, the new field may initially be only visible to the user. The user may then decide to share it with a group of friends, a net, a different user group for example. In some embodiments, if the new object field for the Note item gains enough popularity, the new object field may be provided to other users in the network, either manually by a system administrator or automatically.

In addition, the multiple fields in a form can be used by users as deemed suitable. The advanced functions module 416 can track usage of fields in a particular form. By measuring the facility of the fields, the advanced functions module 416 is able to update the forms to provide optimal usability to a set of users. A form can further includes a number of optional fields, including fields that were user defined, group defined, and/or fields imported from other ontologies and/or namespaces in the network or external to the network, for example, imported from an external data source. Users may sort and/or rate these customized fields based on usability. In addition, the fields can be sorted by who defined the fields, when they were defined/formed/modified, and/or how frequently they are being used.

Forms can be customized and adapted for optimal suitability in a similar fashion to fields. For example, multiple types of objects that can be added to the network can be presented in a ranked list to users. The types that are used more may be placed higher in the list. Similarly, users can create customized types of objects or create additional types to represent the same thing. For example, there may be different type of declared objects for describing a person (e.g., name, relationship, a contact, etc.), where the different types can all be retained and made available, and the more popular types can be ranked higher.

Via the same process as customized fields, customized object types can be provided to expanding groups of users depending on popularity and determined usability in the networking environment. The advanced functions module 416 can also merge, combine, and/or consolidate the alternative definitions by ranking fields by popularity in a single form. Thus, for example, three different definitions of the person class can be made into a composite definition in which the three fields are ranked in order of popularity and/or determined usability. The user can thus access the different definitions in a single form and determine which to use, based on suitability and determined usability, which may be session dependent, user dependent, and/or context dependent.

The host server 400 represents any one or a portion of the functions described for the modules. More or less functions can be included, in whole or in part, without deviating from the novel art of the disclosure.

FIG. 5A illustrates an example user interface 502 showing a user welcome screen, according to one embodiment.

The user welcome screen can be displayed when a user logs on to the knowledge networking environment. In the example shown, the user is able to view notifications indicating recent activities, including, but not limited to, other users that responded to a request made by the user. Requests placed to other users include invitations to join the network, invitation to join a group, and/or invitation to connect, etc. In addition, the home page, in most instances, displays request that the user has received from other users and/or groups. In one embodiment, the home page lists a log of the recent activities of the user. For example, the home page can display a list of pages recently visited, nets recently visited, recent comments, new connections made, new posts to nets, and/or new nets created by the user, etc.

In one embodiment, the user can create a net via the home page. For example, the user can initiate a net (“Twine”) via selecting the ‘Start a Twine’ button 504. In addition, via the home page, the user can add content to the knowledge networking environment via selecting the button ‘Get the Bookmarklet’ 506. In addition, buttons 508 and 510 enable users to import content and post to nets (or “Twine”) via email.

The welcome page 502 can also display a shortcut for nets of interest to the user. For example, the user's nets can be displayed in box 512. In addition, nets that the user is a member of can also be displayed. In most instances, the user can specify the nets to be displayed in the shortcut box and/or the criteria for the system to determine the nets to be displayed. The knowledge networking environment can, in one embodiment, automatically generate tag clouds that can be displayed on the home page, for example, in box 516 on the home page 502.

For example the tag cloud ‘People’ can be populated with tags that are people's names. Similarly, the tag cloud ‘Places’ can be populated with tags that are names of locations, street names, cities, countries, and/or sights, etc. Note that the tags displayed can be those identified in the user's nets, in the users connections' nets, and/or in the entire knowledge networking platform. In some embodiments, sources from which the tags to be displayed on the home page are identified, are user specifiable.

In one embodiment, tag cloud categories are customizable. Users can add an additional tag cloud categories and add tags to the particular tag cloud category. Users can also delete categories or modify the scope of existing categories. For example, instead of having a tag cloud ‘People’, the user may specify a tag cloud of ‘Celebrities’. In a further example, a user may add a category of ‘Products’ and associate items with tags of ‘iPhone’ with the tag cloud ‘Products’.

FIG. 5B-C illustrates an example user interface 520 showing a view of objects (items) in a net and an example user interface 522 for exploring/browsing nets, according to one embodiment.

The user interface 520 illustrates a set of items associated with one of user's (“Bob Hope”) nets. In this example, a list of events is displayed. Note that items that can be included in a net include, in addition to events, but are not limited to, contacts, web pages, videos, images, and/or articles, etc. In addition, a list of tags that are detected in the particular net is displayed in the object view of the net. The number of tags to be displayed may be user specifiable. In addition, the visualization of the tags (e.g., the relative sizes, relative positions, colors, font, etc.) may also be user specifiable.

The user interface 522 provides to the user, an overview of a list of nets (“Twines”) associated with the user. For example, the nets can be displayed as results of a search query. The nets can also be displayed based on identified social proximity between the net and the user. The exploration view of various nets, also, in some embodiments, enables the user to join a net. In addition, the net exploration view can also enable a user to request membership in a net where membership is restricted and/or where approval is required. The user, in some instances, also manages the nets created by the user and/or the nets that the user is an administrator of. For example, the user can select to invite members and/or manage the net. In most instances, the net exploration view also provides general information about the net, including the name of the net, a summary of the net, if applicable, and/or some membership related information.

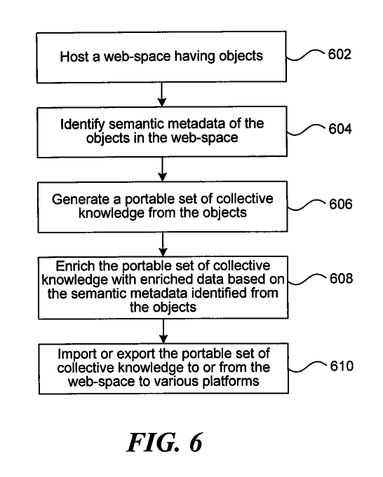

FIG. 6 depicts a flow diagram illustrating an example process for enriching a portable set of collective knowledge, according to one embodiment.

In process 602, a web-space having a plurality of objects is hosted. The plurality of objects can include one or more of, representations of a set of users, a set of web-items, and/or a set of nets. A net typically corresponds to a subset of the web-space comprising a sub-plurality of the plurality of objects. In process 604, semantic metadata of the objects in the web-space is identified. In process 606, a portable set of collective knowledge is generated from the objects.

In process 608, the portable set of collective knowledge is enriched with enriched data based on the semantic metadata identified from the objects. The enriched metadata can include meta-tags or metadata of the plurality of objects. In process 610, the portable set of collective knowledge is imported or exported to or from the web-space to various platforms. The importing and/or exporting can be performed based on automatic or semi-automatic synchronization.

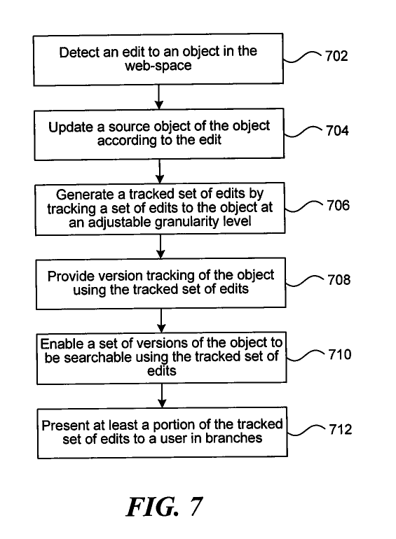

FIG. 7 depicts a flow diagram illustrating an example process for providing version and revision control of an object, according to one embodiment.

In process 702, an edit to an object in the web-space is detected. In process 704, a source object of the object is updated according to the edit. In general, the updating can be performed based on user preferences or default settings.

In process 706, a tracked set of edits is generated by tracking a set of edits to the object at an adjustable granularity level. The granularity level may be set by the system and/or configured/adjusted by a user. In process 708, version tracking of the object is provided using the tracked set of edits. In one embodiment, the tracked sets of edits are time-stamped and/or user-stamped. In addition, each edit of the tracked set of edits may be weighted based on the associated user-stamp.

In process 710, a set of versions of the object is enabled to be searchable using the tracked set of edits. For example, the version of the object edited by a particular person at or around a particular time may be searched for. The versions of the object over a window of time may also be searched for and identified.

In process 712, at least a portion of the tracked set of edits is presented to a user in branches. The branches are typically user modifiable. The branches allow a user to see changes that have been made to a particular object. In the event that conflicting changes have been made, the user can select which ones to keep or discard or to merge the changes.

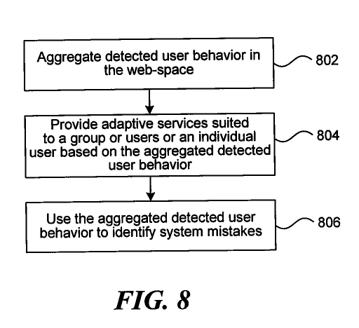

FIG. 8 depicts a flow diagram illustrating an example process for providing adaptive services based on detected user behavior, according to one embodiment.

In process 802, detected user behavior in the web-space is aggregated. In process 804, adaptive services suited to a group or users or an individual user is provided based on the aggregated detected user behavior. In process 806, the aggregated detected user behavior is used to identify system mistakes.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

What is claimed is:

1. A method, comprising:
hosting a web-space having a plurality of objects, the plurality of objects to include one or more of, representations of a set of users, a set of web-items, and a set of nets; wherein a net of the set of nets is a subset of the web-space comprising a sub-plurality of the plurality of objects; and
identifying semantic metadata of the plurality of objects in the web-space.

2. The method of claim 1, further comprising, generating a portable set of collective knowledge from the plurality of objects.

3. The method of claim 2, further comprising, enriching the portable set of collective knowledge with enriched data based on the semantic metadata identified from the plurality of objects.

4. The method of claim 2, further comprising, importing or exporting the portable set of collective knowledge to or from the web-space to various platforms.

5. The method of claim 3, wherein, the enriched data comprises meta-tags or metadata of the plurality of objects.

6. The method of claim 4, wherein, the importing or exporting is performed based on automatic or semi-automatic synchronization.

7. The method of claim 1, further comprising:
detecting an edit to an object of the plurality of objects in the web-space;
updating a source object of the object according to the edit.

8. The method of claim 7, wherein, the updating is performed based on user preferences or default settings.

9. The method of claim 1, further comprising, generating a tracked set of edits by tracking a set of edits to the object at an adjustable granularity level.

10. The method of claim 9, further comprising, providing version tracking of the object using the tracked set of edits.

11. The method of claim 9, wherein the tracked set of edits are time-stamped or user-stamped.

12. The method of claim 11, wherein, each edit of the tracked set of edits is weighted based on the associated user-stamp.

13. The method of claim 9, further comprising, enabling a set of versions of the object to be searchable using the tracked set of edits.

14. The method of claim 9, further comprising, presenting at least a portion of the tracked set of edits to a user in branches; wherein the branches are user modifiable.

15. The method of claim 1, further comprising, providing adaptive services suited to a group or users or an individual user based on aggregating detected user behavior in the web-space.

16. The method of claim 15, further comprising, using the aggregated detected user behavior to identify system mistakes.

17. The method of claim 1, wherein the object of the plurality of objects comprises an object field that is user editable or user definable.

18. The method of claim 1, wherein, the object comprises a user-defined object field; wherein the user-defined object field is visible to other users and rank-able by other users.

19. A system, comprising:
means for, hosting a web-space having a plurality of objects, the plurality of objects to include one or more of, representations of a set of users, a set of web-items, and a set of nets; wherein a net of the set of nets is a subset of the web-space comprising a sub-plurality of the plurality of objects;
means for, identifying semantic metadata of the plurality of objects in the web-space; and
means for, generating a portable set of collective knowledge from the plurality of objects; and
means for, enriching the portable set of collective knowledge with enriched data based on the semantic metadata identified from the plurality of objects.

20. The system of claim 19, further comprising:
means for, in response to receiving a request from an administrator user, creating a first net in the web-space; the user to be designated as having a membership status of an administrative member of the first net;
means for, associating one or more web-items with the first net responsive to a request of the net administrator;
means for, setting membership criteria of the first net governing user association with the first net, the membership criteria to be specifiable by the net administrator;
means for, setting access rights of the web-items in the first net to be one or more of a pre-determined set of tiered access levels, the access rights to be specifiable by the net administrator based on the memberships status of users;
means for, associating a user with the first net, in response to receiving a request from one or more of the net administrator and the user, the request for membership from the user to be granted when in compliance with the membership criteria; the user to be designated as having a membership status of a member of the first net; and
means for, presenting a web-item of the first net to a requesting party, responsive to a request from the requesting party when in compliance with the access right of the web-item, the requesting party to be one or more of the administrative member, a member, and a visitor of the first net.

21. A machine-readable medium having stored thereon a set of instructions which when executed perform a method, comprising:
hosting a web-space having a plurality of objects, the plurality of objects to include one or more of, representations of a set of users, a set of web-items, and a set of nets; wherein a net of the set of nets is a subset of the web-space comprising a sub-plurality of the plurality of objects;
identifying semantic metadata of the plurality of objects in the web-space; and
generating a portable set of collective knowledge from the plurality of objects.
